(19) United States
(12) Patent Application Publication
(10) Pub. No.: US 2022/0393260 A1
(43) Pub. Date: Dec. 8, 2022

(54) BATTERY HEAT EXCHANGE STRUCTURE

(71) Applicant: SANKEI GIKEN KOGYO CO., LTD., Tokyo (JP)

(72) Inventors: Keisuke Nakamura, Isesaki-shi (JP); Ryuho Ikemasu, Isesaki-shi (JP)

(73) Assignee: SANKEI GIKEN KOGYO CO., LTD., Tokyo (JP)

(21) Appl. No.: 17/775,154

(22) PCT Filed: Sep. 25, 2020
(86) PCT No.: PCT/JP2020/036224

§ 371 Date: May 6, 2022

(30) Foreign Application Priority Data
Nov. 26, 2019 (JP) 2019-212958

(51) Int. Cl. H01M 10/613; B60L 50/64; H01M 10/615; H01M 10/48; H01M 10/6556; H01M 10/6568

(52) U.S. Cl. CPC H01M 10/613; B60L 50/64; H01M 10/615; H01M 10/486; H01M 10/6556; H01M 10/6568; H01M 2220/20

(57) ABSTRACT

A battery heat exchange structure in which a battery cell 41 and a heat exchange panel 42 are closely arranged side by side so that a heat exchange surface 421 of the heat exchange panel 42 follows a side surface 411 of the battery cell 41, the heat exchange panel 42 is formed so that a heat exchange fluid F can be recirculated along the heat exchange surface 421, and the heat exchange panel 42 and the battery cell 41 are elastically urged so as to be compressed in the arrangement direction. This battery heat exchange structure can increase heat exchange efficiency between the heat exchange panel and the battery cell and can increase the stability of heat exchange.

### TECHNICAL FIELD

The present invention relates to a battery heat exchange structure that exchanges heat with a battery of an electric vehicle or the like.

### BACKGROUND ART

Conventionally, as a structure for exchanging heat with an automobile battery, a structure in which a refrigerant circuit for extracting heat from the battery is provided, heat is transferred through the refrigerant, and the transferred heat is supplied to an air conditioner is known (see Patent Literatures 1 and 2).

### CITATION LIST

### Patent Literature

[PTL 1] Japanese Patent Application Publication No. 2011-230648
[PTL 2] Japanese Patent Application Publication No. 2015-182487

### SUMMARY OF INVENTION

### Technical Problem

By the way, in order to efficiently extract and collect the heat from the battery for the purpose of effectively utilizing the heat as in Patent Literatures 1 and 2, it is necessary to install a heat exchange structure having high heat exchange efficiency in the battery.

In addition, the battery has a problem that the output voltage and the discharge capacity decrease and the battery performance decreases temporarily in a low-temperature external environment due to cold weather or cold regions. On the other hand, the battery has another problem that the permanent performance of the battery deteriorates and the battery life is shortened when the high temperature state continues. Therefore, a structure capable of controlling the temperature of the battery to be in an appropriate temperature range is also required.

The present invention is proposed in view of the above-described problems, and an object thereof is to provide a battery heat exchange structure capable of increasing the heat exchange efficiency between the heat exchange panel and the battery cell and improving the stability of heat exchange. Another object of the present invention is to provide a battery heat exchange structure capable of controlling the temperature of the battery to be in an appropriate temperature range when necessary.

### Solution to Problem

In a battery heat exchange structure of the present invention, battery heat exchange structure in which a battery cell and a heat exchange panel are closely arranged side by side so that a heat exchange surface of the heat exchange panel follows a side surface of the battery cell, the heat exchange panel is formed so that a heat exchange fluid can be recirculated along the heat exchange surface, and the heat exchange panel and the battery cell are elastically urged so as to be compressed in the arrangement direction.

According to this configuration, since the battery cells and the heat exchange panel are in close contact with each other so that the side surface of a necessary battery cell follows the heat exchange surface of the heat exchange panel, heat exchange between the battery cell and the heat exchange fluid of the heat exchange panel can be performed with high heat exchange efficiency. Further, the heat exchange panel and the battery cell are elastically urged so as to be compressed and pressed in the arrangement direction, the heat exchange efficiency between the battery cell and the heat exchange fluid of the heat exchange panel can be further improved, and the stability of heat exchange can be enhanced. Further, since the heat exchange panel and the battery cell are elastically urged in the arrangement direction, it is possible to secure a state in which the heat exchange panel and the battery cell are pressed in the arrangement direction following the thermal expansion of the battery and the contraction when the temperature drops. In addition, since the heat exchange panel and the battery cell are elastically urged in the arrangement direction, it is possible to absorb the amount of expansion during thermal expansion of the battery, prevent damage to the heat exchange structure due to an increase in internal pressure, and improve safety.

In the battery heat exchange structure of the present invention, the battery cell and the heat exchange panel are closely arranged side by side between one holding plate provided at one end in the arrangement direction and the other holding plate provided at the other end, and the battery cell and the heat exchange panel are urged by an elastic material from an outer side of one holding plate or from both outer sides of both holding plates so that a compressive force is applied substantially uniformly to the heat exchange surface of the heat exchange panel.

According to this configuration, the heat exchange surface of the heat exchange panel can be pressed substantially uniformly against the side surface of the battery cell via the holding plate, the heat exchange efficiency between the battery cell and the heat exchange fluid of the heat exchange panel can be further improved, and the stability of heat exchange can be further improved.

In the battery heat exchange structure of the present invention, a portion of a fluid supply pipe for supplying the heat exchange fluid to the heat exchange panel and a portion of a fluid discharge pipe for discharging the heat exchange fluid from the heat exchange panel are provided so as to follow the arrangement direction, and the heat exchange fluid supplied by the fluid supply pipe is distributed and recirculated to a plurality of heat exchange panels arranged side by side, and is discharged from the heat exchange panels so as to be collected in the fluid discharge pipe.

According to this configuration, by providing only parts and components that branch the fluid supply pipe and the fluid discharge pipe corresponding to the main pipe, the heat exchange fluid can flow into the plurality of heat exchange panels and the heat exchange fluid can flow out from the plurality of heat exchange panels. Thus, it is possible to reduce the number of members, reduce the manufacturing cost, and improve the efficiency of the assembly process.

In the battery heat exchange structure of the present invention, a portion of the fluid supply pipe between the heat exchange panels and a portion of the fluid discharge pipe between the heat exchange panels are formed of an elastic pipe.

According to this configuration, when the portion of the fluid supply pipe and the portion of the fluid discharge pipe are provided so as to follow the arrangement direction of the battery cell and the heat exchange panel, the elastic pipe expands to follow when the battery cell thermally expands due to heat generation, and elastically restores according to the convergence of the thermal expansion, and the thermal expansion can be absorbed by the fluid supply pipe and the fluid discharge pipe.

In the battery heat exchange structure of the present invention, a battery body including the battery cell and the heat exchange panel, and a support portion for supporting the battery body are housed in an insulating container.

According to this configuration, the influence of the temperature of the external environment on the battery can be reduced. In other words, it is possible to prevent a temporary deterioration of the battery performance such as a decrease in the output voltage of the battery and a decrease in the discharge capacity, which occur in a low-temperature external environment. Moreover, it is possible to prevent a permanent deterioration of the battery performance and shortening of the battery life, which occur in a high-temperature external environment. Further, when the battery body is equipped with a protection circuit that regulates the output at a very high temperature, it is possible to prevent the protection circuit from operating unexpectedly at a very high temperature in the summer. Further, it is possible to control the battery temperature to be in an appropriate temperature range as necessary by the recirculation of the heat exchange fluid while reducing the influence of the temperature of the external environment.

In the battery heat exchange structure of the present invention, the insulating container is a double-walled insulating container including an insulating container main body in which an insulating space is provided between an inner wall and an outer wall, and an insulating lid in which an insulating space is provided between an inner lid and an outer lid, and the battery body is arranged to be spaced apart from the inner wall of the insulating container main body and the inner lid of the insulating lid.

According to this configuration, it is possible to be adapted to both a very low-temperature outside hearing environment and a very high-temperature outside hearing environment, and reduce the influence of the temperature of the external environment on the batter as much as possible. In other words, it is possible to prevent a temporary deterioration of the battery performance such as a decrease in the output voltage of the battery and a decrease in the discharge capacity, which occur in a low-temperature external environment. Moreover, it is possible to prevent a permanent deterioration of the battery performance and shortening of the battery life, which occur in a high-temperature external environment. Further, when the battery body is equipped with a protection circuit that regulates the output at a very high temperature, it is possible to prevent the protection circuit from operating unexpectedly at a very high temperature in the summer.

In the battery heat exchange structure of the present invention, a temperature sensor for detecting a temperature of the battery cell is provided close to the battery cell, and a heat exchange fluid control unit supplies the heat exchange fluid having a required temperature according to a detection temperature from the temperature sensor.

According to this configuration, the heat exchange fluid having a required temperature can be recirculated as necessary according to the detection temperature from the temperature sensor, and the temperature of the battery can be automatically controlled to be in an appropriate temperature range.

### Advantageous Effects of Invention

According to the battery heat exchange structure of the present invention, it is possible to improve the heat exchange efficiency between the heat exchange panel and the battery cell, and improve the stability of heat exchange.

### BRIEF DESCRIPTION OF DRAWINGS

FIG. 1 is a plan view of a battery insulation structure according to an embodiment of the present invention.

FIG. 2 is an enlarged cross-sectional view taken along the line A-A in FIG. 1.

FIG. 3 is an enlarged view taken along the line B-B in FIG. 2.

FIG. 4 is an enlarged view of the part C in FIG. 3.

FIG. 5 is a longitudinal explanatory view of a heat exchange panel in the battery heat exchange structure of the embodiment.

FIG. 6 is a block diagram showing a control configuration of a battery heat exchange structure and a heat exchange fluid according to the embodiment.

### DESCRIPTION OF EMBODIMENTS

[Battery Heat Exchange Structure of Embodiment]

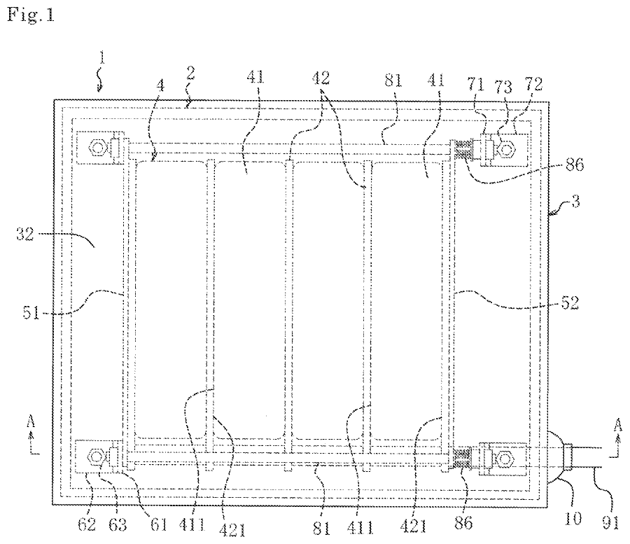

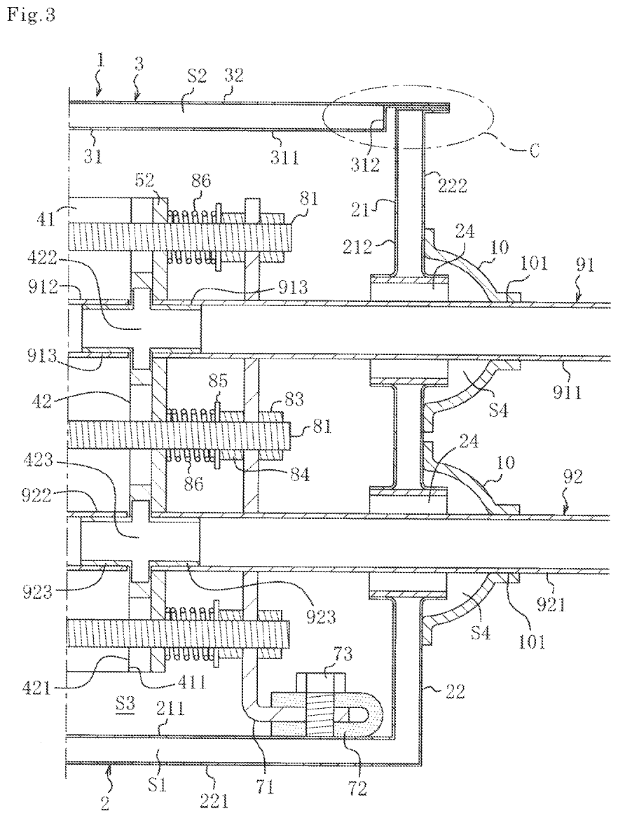

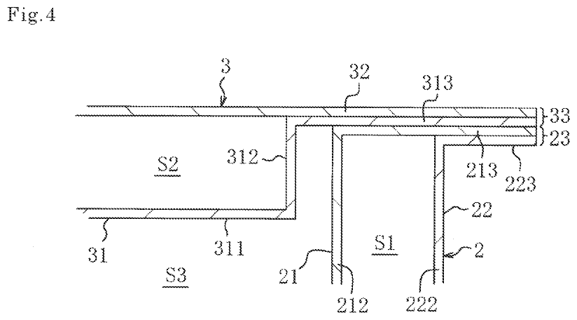

As shown in FIGS. 1 to 4, a battery heat exchange structure of an embodiment according to the present invention includes a double-walled insulating container 1 composed of an insulating container main body 2 and an insulating lid 3, and a battery body 4 housed in the insulating container 1. In the battery body 4, as will be described later, heat exchange is performed between the battery cell 41 and the heat exchange fluid F flowing through the heat exchange panel 42.

The insulating container main body 2 is formed in a substantially rectangular box shape with an open upper surface, and has a double-wall structure including a substantially rectangular box-shaped inner wall 21 with an open upper surface and a substantially rectangular box-shaped outer wall 22 with an open upper surface. A bottom portion 211 of the inner wall 21 and a bottom portion 221 of the outer wall 22, and a peripheral side portion 212 of the inner wall 21 and a peripheral side portion 222 of the outer wall 22 are arranged to be spaced apart from each other, and an insulating space S1 is provided between the inner wall 21 and the outer wall 22. The insulating space S1 is preferably a vacuumed decompression space, but it can also be an air layer, and the insulating space S1 of the present embodiment is hollow but a solid insulating material may be filled in the insulating space S1.

A flat flange 213 protruding outward is formed at the upper end of the peripheral side portion 212 of the inner wall 21, and a flat flange 223 protruding outward is formed at the upper end of the peripheral side portion 22 of the outer wall 22. The flange 213 is overlapped so as to be placed on the flange 223, the ends of the inner wall 21 and the outer wall 22 are sealed, and the flanges are fixed by welding or the like at the overlapping position, whereby a container-side flat flange 23 is formed.

The insulating lid 3 is formed in a substantially flat plate shape, and has a double-wall structure including a thin dish-shaped inner lid 31 whose center is recessed from the peripheral edge and a flat plate-shaped outer lid 32. The inner lid 31 has a substrate 311 and an erected portion 312 that stands around the substrate 311 and a flange 313 that protrudes outward from the upper end of the erected portion 312. The substrate 311 of the inner lid 31 and the outer lid 32 are arranged to be spaced apart from each other, and an insulating space S2 is provided between the substrate 311 of the inner lid 31 and the outer lid 32, in other words, between the inner lid 31 and the outer lid 32. The insulating space S2 is also preferably a vacuumed decompression space, but it can also be an air layer, and the insulating space S2 of the present embodiment is hollow but a solid insulating material may be filled in the insulating space S2.

The outer lid 32 is overlapped so as to be placed on the flange 313 of the inner lid 31. The ends of the inner lid 31 and the outer lid 32 are sealed, and the lids are fixed by welding or the like at the position where the outer lid 32 is overlapped with the flange 313 of the inner lid 31, whereby a lid-side flat flange 33 is formed.

The insulating container 1 is closed in such a way that a lower surface of the lid-side flat flange 33 having a planar area equal to or larger than the container-side flat flange 23 of the insulating lid 3 is overlapped so as to be placed on an upper surface of the container-side flat flange 23 having a planar area larger than the planar area at the upper end position of the insulating space S1 of the insulating container main body 2 and the insulating lid 3 engages with the insulating container main body 2. The container-side flat flange 23 and the lid-side flat flange 33, which are overlapped in a state where the planar contact area is larger than the planar area at the upper end position of the insulating space S1, are detachably fixed by fixing members such as bolts and nuts (not shown).

By closing the insulating container 1 by increasing the mutual contact area at the contact position of the insulating container main body 2 and the insulating lid 3, the airtightness, the sealing property, and the insulating property at the contact position between the insulating container main body 2 and the insulating lid 3 can be improved. It is also preferable to provide a sealing material between the container-side flat flange 23 and the lid-side flat flange 33, and to place the lid-side flat flange 33 on the container-side flat flange 23 via the sealing material interposed therebetween.

The outer peripheral dimensions of the substrate 311 and the erected portion 312 of the inner lid 31 of the insulating lid 3 are formed to be slightly smaller than the inner peripheral dimension at the upper end position of the inner wall 21 of the insulating container main body 2. In the closed state of the insulating container 1, the substrate 311 and the erected portion 312 of the inner lid 31 of the insulating lid 3 are tightly or loosely fitted inside the inner wall 21 of the insulating container main body 2, and the insulating lid 3 engages with the insulating container main body 2.

The battery body 4 of the present embodiment has a plurality of battery cells 41 provided side by side at predetermined intervals, and heat exchange panels 42 provided on both sides of each battery cell 41 in the arrangement direction to circulate heat exchange fluid E. The battery body 4 has a stacked structure in which the battery cell 41 and the heat exchange panel 42 are closely and alternately stacked. In the battery body 4, the battery cell 41 and the heat exchange panel 42 are closely and alternately arranged side by side so that the heat exchange surface 421 of the heat exchange panel 42 follows the side surface 411 of the battery cell 41.

Holding plates 51 and 52 are provided on the outer sides of the heat exchange panels 42 and 42 located at both ends in the arrangement direction of the battery cell 41 and the heat exchange panel 42 of the battery body 4. In other words, the battery cell 41 and the heat exchange panel 42 are closely and alternately arranged side by side between one holding plate 51 provided at one end in the arrangement direction of the battery cell 41 and the heat exchange panel 42 and the other holding plate 52 provided at the other end. The battery cell 41 and the heat exchange panel 42 are installed in the insulating container 1 so as to be sandwiched between the holding plates 51 and 52.

A side portion of a substantially L-shaped support stay 61 is arranged adjacent to the outer side of the holding plate 51 on one side in the arrangement direction of the battery cell 41 and the heat exchange panel 42, and the lower portion of the support stay 61 is engaged with an insulating material 62 such as an insulating rubber having a substantially U-shaped cross-section fixed to the bottom portion 211 of the inner wall 21 of the insulating container main body 2 and is fixed to the insulating material 62 by tightening a bolt 63. That is, the battery body 4 sandwiched between the holding plates 51 and 52 is installed with the insulating material 62 fixed to the inner wall 21 of the insulating container main body 2 interposed therebetween. The support stay 61, the insulating material 62, and the bolt 63 are arranged near both ends of the holding plate 51 on one side in a direction orthogonal to the arrangement direction of the battery cell 41 and the heat exchange panel 42 in the plan view of the insulating container 1.

A side portions of a substantially L-shaped support stay 71 is arranged at an interval from the holding plate 52 on the outer side of the holding plate 52 on the other side in the arrangement direction of the battery cell 41 and the heat exchange panel 42, and the lower portion of the support stay 71 is also engaged with an insulating material 72 such as an insulating rubber having a substantially U-shaped cross-section fixed to the bottom portion 211 of the inner wall 21 of the insulating container main body 2 and is fixed to the insulating material 72 by fastening a bolt 73. That is, the battery body 4 sandwiched between the holding plates 51 and 52 is installed with the insulating material 72 fixed to the inner wall 21 of the insulating container main body 2 interposed therebetween. The support stay 71, the insulating material 72, and the bolt 73 are arranged at positions corresponding to both ends of the holding plate 52 on the other side in a direction orthogonal to the arrangement direction of the battery cell 41 and the heat exchange panel 42 in the plan view of the insulating container 1.

A shaft bolt 81 is provided so as to penetrate the support stay 61, the holding plate 51, the holding plate 52, and the support stay 71. The shaft bolts 81 are provided on both sides of a direction orthogonal to the arrangement direction of the battery cell 41 and the heat exchange panel 42, and in the shown example, the shaft bolts 81 are provided at three locations in the upward and downward direction (six locations in total). A nut 82 is screwed into the shaft bolt 81 in close contact with the support stay 61 on the outer side of the support stay 61, a nut 83 is screwed in close contact with the support stay 71 on the outer side of the support stay 71, and a nut 84 is screwed in close contact with the support stay 71 on the inner side of the stay 71. A washer 85 is arranged on the holding plate 52 side of the nut 84.

A coil spring 86 is provided as an elastic material between the washer 85 and the holding plate 52, and the coil spring 86 is externally inserted to the outer periphery of the shaft bolt 81. The coil spring 86 presses and urges the holding plate 52 toward the holding plate 51 by elastic restoration, whereby the battery body 4 in which the battery cell 41 and the heat exchange panel 42 are closely and alternately stacked is sandwiched between the holding plate 51 and the holding plate 52 by the urging force. In other words, the heat exchange panel 42 and the battery cell 41 are provided so as to be elastically urged to be compressed in the arrangement direction.

A plurality of coil springs 86 in the present embodiment are provided so as to correspond to positions corresponding to the vicinities of the four corners of the substantially rectangular holding plates 51 and 52 and the substantially rectangular heat exchange panel 42 provided to be overlapped so as to correspond to the positions of the four corners thereof and substantially intermediate positions of the positions near the four corners. The coil springs 86 are arranged at well-balanced intervals with respect to the heat exchange surface 421 of the heat exchange panel 42. The battery cells 41 and the heat exchange panel 42 arranged side by side so that the compressive force is applied substantially uniformly to the heat exchange surface 421 of the heat exchange panel 42 are urged by the plurality of coil springs 86 arranged at well-balanced intervals. The coil spring 86 also has a function of absorbing the expansion amount due to the thermal expansion by contraction deformation while maintaining the sandwiching state of the battery body 4 when the battery cell 41 thermally expands due to heat generation.

In the present embodiment, the elastic coil spring 86 is provided on the outer side of the other holding plate 52 as the outer side of one holding plate to urge the battery cell 41 and the heat exchange panel 42 arranged side by side. However, the elastic coil spring 86 may be provided on the outer side of one holding plate 51 on the opposite side to urge the battery cell 41 and the heat exchange panel 42 arranged side by side. Alternatively, the elastic coil spring 86 may be provided on both outer sides of both holding plates 51 and 52 to urge the battery cell 41 and the heat exchange panel 42 arranged side by side. Further, as the elastic material for urging the battery cell 41 and the heat exchange panel 42 arranged side by side, a spring, a rubber material, or the like other than the coil spring 86 can be appropriately used.

The battery body 4 composed of the battery cell 41 and the heat exchange panel 42, the holding plates 51 and 52 corresponding to the support portion for supporting the battery body 4, the support stays 61 and 71, the insulating materials 62 and 72, the bolts 63 and 73, the shaft bolt 81, the nuts 82, 83, and 84, the washer 85, and the coil spring 86 are housed in the insulating container 1. The battery body 4 supported by the urging of the coil spring 86 and the sandwiching of the holding plates 51 and 52 is arranged to be spaced apart from the inner wall 21 of the insulating container main body 2 and the inner lid 31 of the insulating lid 3, and an insulating space S3 is also formed inside the insulating container 1.

In the battery heat exchange structure of the present embodiment, a fluid supply pipe 91 for supplying the heat exchange fluid F to the heat exchange panel 42 and a fluid discharge pipe 92 for discharging the heat exchange fluid F from the heat exchange panel 42 are provided so as to penetrate the inner wall 21 and the outer wall 22 of the insulating container main body 2. The portion of the fluid supply pipe 91 arranged in the insulating container 1 corresponding to a portion of the fluid supply pipe 91 and the portion of the fluid discharge pipe 92 arranged in the insulating container 1 corresponding to a portion of the fluid discharge pipe 92 are arranged so as to follow the arrangement direction of the battery cell 41 and the heat exchange panel 42 and are provided in parallel to the arrangement direction.

The fluid supply pipe 91 includes a fluid introduction pipe 911, a connecting pipe 912 composed of an elastic pipe such as a rubber tube that can be elastically restored and stretched, and a protruding pipe 913 that protrudes in the panel normal direction from the inlet port of the heat exchange panel 42. The fluid introduction pipe 911 is composed of an elastic pipe such as a rubber tube that can be elastically restored and stretched, and is externally inserted and attached to the protruding pipe 913 of the heat exchange panel 42 that is arranged at the nearest position. The protruding pipes 913 and 913 of the heat exchange panels 42 and 42 arranged side by side are connected to each other via the connecting pipe 912, and both ends of the connecting pipe 912 are externally inserted and attached to the protruding pipe 913. That is, the portion of the fluid supply pipe 81 between the heat exchange panels 42 and 42 is configured by the elastic connecting pipe 912. The connecting pipe 912 composed of an elastic pipe elastically expands to follow thermal expansion when the battery cell 41 thermally expands due to heat generation, and elastically restores according to the convergence of the thermal expansion to be adaptable to the thermal expansion.

The fluid discharge pipe 92 includes a fluid lead-out pipe 921, a connecting pipe 922 composed of an elastic pipe such as a rubber tube that can be elastically restored and stretched, and a protruding pipe 923 that protrudes in the panel normal direction from the outlet port of the heat exchange panel 42. The fluid lead-out pipe 921 is also composed of an elastic pipe such as a rubber tube that can be elastically restored and stretched, and is externally inserted and attached to the protruding pipe 923 of the heat exchange panel 42 that is arranged at the nearest position. The protruding pipes 923 and 923 of the heat exchange panels 42 and 42 arranged side by side are connected to each other via the connecting pipe 922, and both ends of the connecting pipe 922 are externally inserted and attached to the protruding pipe 923. That is, the portion of the fluid discharge pipe 92 between the heat exchange panels 42 and 42 is configured by the elastic connecting pipe 922. The connecting pipe 922 composed of an elastic pipe elastically expands to follow thermal expansion when the battery cell 41 thermally expands due to heat generation, and elastically restores according to the convergence of the thermal expansion to be adaptable to the thermal expansion.

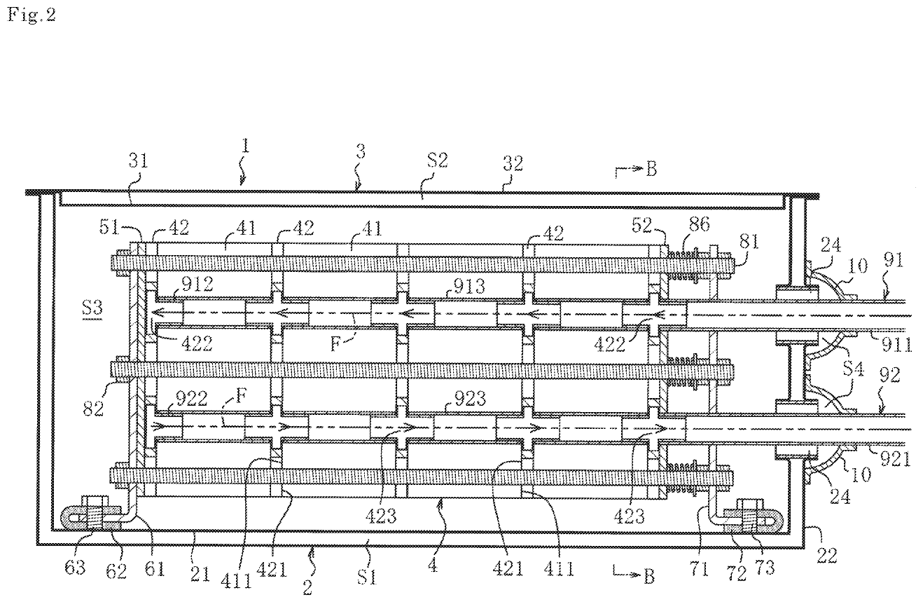

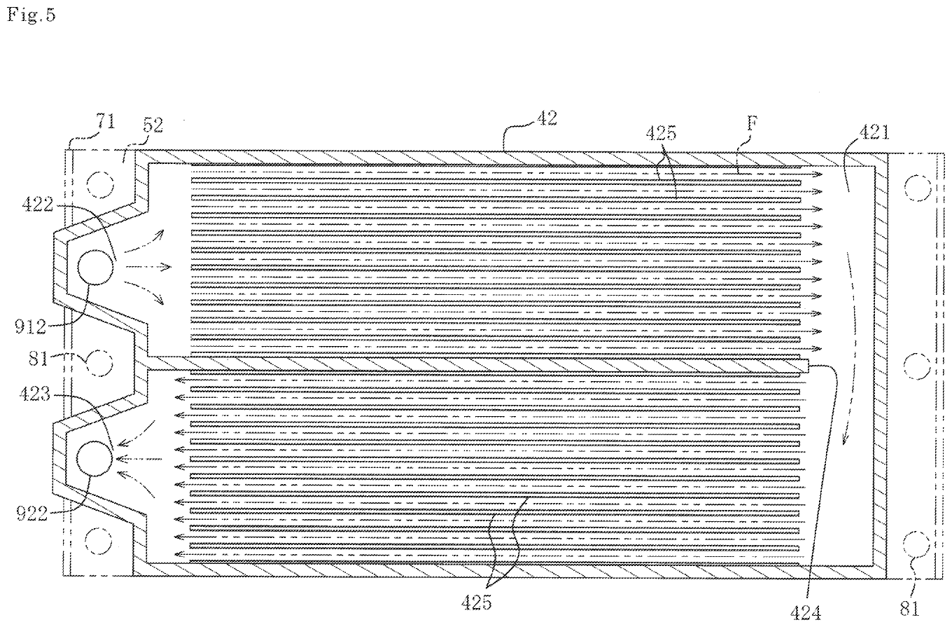

As shown in FIGS. 2 and 5, the heat exchange fluid F such as cooling water supplied by the fluid supply pipe 91 is distributed by flowing into the respective heat exchange panels 42 from the inlet port 422 communicating with the protruding pipe 913. The heat exchange fluid F recirculates in the heat exchange panel 42 along the heat exchange surface 421, and is discharged to the outside through the fluid discharge pipe 92 so as to be collected in the fluid discharge pipe 92 from the outlet port 423 communicating with the protruding pipes 923 of the respective heat exchange panels 42.

The heat exchange panel 42 is provided with partitions 424 and 425 that form a flow path for recirculating the heat exchange fluid F along the heat exchange surface 421 over substantially the entire heat exchange surface 421. Since the heat exchange fluid F flows along the flow path formed by the partitions 424 and 425, the heat exchange between the battery cell 41 and the heat exchange fluid F flowing through the heat exchange panel 42 is enhanced. When the heat exchange panel 42 is, for example, a thin panel having a thickness of 4 mm or less, the installation space can be satisfactorily saved.

The insulating container main body 2 is provided with penetrating portions 24 formed by fixing a short cylinder or the like so as to maintain a closed state of the insulating space S1 between the inner wall 21 and the outer wall 22. The fluid supply pipe 91 and the fluid introduction pipe 911 are provided so as to penetrate each of the penetrating portions 24. In this way, the fluid supply pipe 91 and the fluid discharge pipe 92 are connected to the inside and outside of the insulating container 1 through the penetrating portion 24.

Around the penetrating portion 24, a substantially concave cap 10 is fixed to the outer surface of the insulating container 1 with the concave side facing the outer surface of the insulating container 1. In the present embodiment, the cap 10 is fixed by welding or the like to the outer surface of the outer wall 22 of the insulating container main body 2. An insertion hole 101 is formed substantially in the center of the cap 10, and the fluid introduction pipe 911 and the fluid lead-out pipe 921 are inserted into the insertion hole 101. An insulating space S4 surrounded by the cap 10, the outer surface of the outer wall 22, and the outer surface of the fluid introduction pipe 911 or the fluid lead-out pipe 921 is provided on the concave side of the substantially concave cap 10 (in the shown example, the bowl-shaped cap 10).

According to the battery heat exchange structure of the present embodiment, since the battery cells 41 and the heat exchange panel 42 are in close contact with each other so that the side surface 411 of each battery cell 41 follows the heat exchange surface 421 of the heat exchange panel 42, heat exchange between the battery cell 41 and the heat exchange fluid F of the heat exchange panel 42 can be performed with high heat exchange efficiency. Further, the heat exchange panel 42 and the battery cell 41 are elastically urged so as to be compressed and pressed in the arrangement direction, the heat exchange efficiency between the battery cell 41 and the heat exchange fluid F of the heat exchange panel 42 can be further improved, and the stability of heat exchange can be enhanced. Further, since the heat exchange panel 42 and the battery cell 41 are elastically urged in the arrangement direction, it is possible to secure a state in which the heat exchange panel 42 and the battery cell 41 are pressed in the arrangement direction following the thermal expansion of the battery and the contraction when the temperature drops. In addition, since the heat exchange panel 42 and the battery cell 41 are elastically urged in the arrangement direction, it is possible to absorb the amount of expansion during thermal expansion of the battery, prevent damage to the heat exchange structure due to an increase in internal pressure, and improve safety.

The heat exchange surface 421 of the heat exchange panel 42 can be pressed substantially uniformly against the side surface 411 of the battery cell 41 via the holding plates 51 and 52 by the urging of the coil spring 86, the heat exchange efficiency between the battery cell 41 and the heat exchange fluid F of the heat exchange panel 42 can be further improved, and the stability of heat exchange can be further improved.

Since a portion of the fluid supply pipe 91 and a portion of the fluid discharge pipe 92 are provided so as to follow the arrangement direction of the battery cell 41 and the heat exchange panel 42, by providing only parts and components that branch the fluid supply pipe 91 and the fluid discharge pipe 92 corresponding to the main pipe, the heat exchange fluid F can flow into the plurality of heat exchange panels 42 and the heat exchange fluid F can flow out from the plurality of heat exchange panels 42. Thus, it is possible to reduce the number of members, reduce the manufacturing cost, and improve the efficiency of the assembly process.

Due to the elastic connecting pipe 912 corresponding to the part of the fluid supply pipe 91 between the heat exchange panels 42 and 42 and the elastic connecting pipe 922 corresponding to the part of the fluid discharge pipe 92 between the heat exchange panels 42 and 42, the elastic pipe expands to follow when the battery cell 41 thermally expands due to heat generation, and elastically restores according to the convergence of the thermal expansion, and the thermal expansion can be absorbed by the fluid supply pipe 91 and the fluid discharge pipe 92.

Since the battery body 4 including the battery cell 41 and the heat exchange panel 42 and the support portion for supporting the battery body 4 are housed in the insulating container 1, the influence of the temperature of the external environment on the battery can be reduced. In other words, it is possible to prevent a temporary deterioration of the battery performance such as a decrease in the output voltage of the battery and a decrease in the discharge capacity, which occur in a low-temperature external environment. Moreover, it is possible to prevent a permanent deterioration of the battery performance and shortening of the battery life, which occur in a high-temperature external environment. Further, when the battery body 4 is equipped with a protection circuit that regulates the output at a very high temperature, it is possible to prevent the protection circuit from operating unexpectedly at a very high temperature in the summer. In particular, in the present embodiment, since the insulating spaces S1 and S2 are provided in the insulating container 1 and the battery body 4 is housed in the insulating container 1 so as to be spaced apart from the insulating container 1, these effects can be further enhanced.

The temperature of the battery can be controlled to be in an appropriate temperature range when necessary by the recirculation of the heat exchange fluid F. For example, when the battery cell 41 generates heat and is in a high temperature state, the low-temperature heat exchange fluid F can be passed through the fluid supply pipe 91, the heat exchange panels 42, and the fluid discharge pipe 92 to exchange heat, and the temperature of the battery cell 41 can be decreased to be in an appropriate temperature range to prevent permanent deterioration of battery performance and shortening of life. When the battery cell 41 is in a low temperature state, the high-temperature heat exchange fluid F can be passed through the fluid supply pipe 91, the heat exchange panels 42, and the fluid discharge pipe 92 to exchange heat, and the temperature of the battery cell 41 can be raised to be in an appropriate temperature range to prevent a decrease in output voltage and a decrease in discharge capacity.

Further, when the temperature of the battery cell 41 in a low temperature state is raised to an appropriate temperature range, since the temperature can be raised without using the heating of the heater that uses the electric power of the battery, it is possible to prevent a decrease in the cruising distance of an automobile, for example. The heat collected via the heat exchange fluid F by the heat exchange between the high-temperature battery cell 41 and the heat exchange fluid F can be supplied to the battery or other places where heat is needed when necessary by a heat storage device or the like separately provided.

### SCOPE OF INCLUSION OF INVENTION DISCLOSED IN PRESENT SPECIFICATION

The invention disclosed in the present specification includes, in addition to the inventions listed as inventions and embodiments, those specified by changing the partial contents thereof to other contents disclosed in the present specification to an applicable extent, those specified by adding other contents disclosed in the present specification to these contents, or those specified by deleting these partial contents to the extent that a partial action and effect can be obtained and making them into a higher concept. The invention disclosed in the present specification also includes the following modifications and additional contents.

For example, the insulating container in which the battery cell and the heat exchange panel of the present invention are housed is preferably the insulating container 1 of the above-described embodiment, but they can also be housed in an insulating container other than the insulating container 1 of the above-described embodiment. The present invention also includes a configuration in which the battery cell and the heat exchange panel of the present invention are not housed in the insulating container.

The shape and number of penetrating portions 24 provided in the double wall of the insulating container 1 with the insulating spaces S1 and S2 closed may be changed appropriately. For example, the penetrating portion 24 through which the battery cable is passed, the penetrating portion 24 through which the fluid supply pipe 91 is passed, and the penetrating portion 24 through which the fluid discharge pipe 92 is passed may be provided individually. Alternatively, both the battery cable and the fluid supply pipe 91 or the fluid discharge pipe 92 may be passed through one penetrating portion 24.

Any fluid other than the cooling water may be appropriately used as the heat exchange fluid of the present invention, and a low-temperature liquid or gas, a high-temperature liquid or gas, or both may be appropriately used as needed.

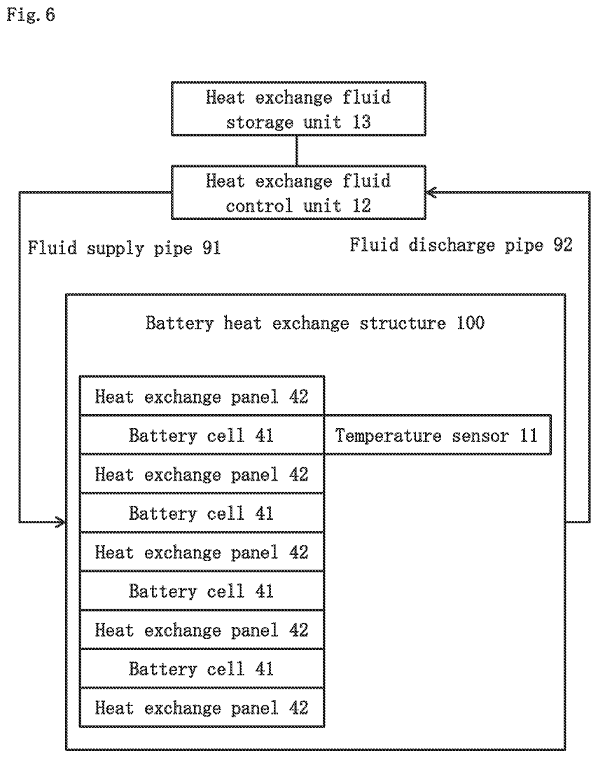

In the battery heat exchange structure of the present invention, as shown in FIG. 6, it may be preferable that a temperature sensor 11 for detecting the temperature of the battery cell 41 of the battery heat exchange structure 100 is provided close to the battery cell 41, and a heat exchange fluid control unit 12 supplies the heat exchange fluid F having a required temperature of a heat exchange fluid storage unit 13 according to the detection temperature from the temperature sensor 11. In this way, the heat exchange fluid F having a required temperature can be recirculated as necessary according to the detection temperature from the temperature sensor 11, and the temperature of the battery can be automatically controlled to be in an appropriate temperature range. The communication between the heat exchange fluid control unit 12 and the temperature sensor 11 can be performed by wired communication using a cable provided through the penetrating portion 24 or the like or wireless communication.

The battery heat exchange structure of the present invention is not limited to the configuration in which the battery cell 41 and the heat exchange panel 42 of the above-described embodiment are closely and alternately arranged side by side. The battery heat exchange structure of the present invention includes that the battery cell and the heat exchange panel are closely arranged side by side so that the heat exchange surface of the heat exchange panel follows the side surface of the battery cell. For example, even when the battery cell and the heat exchange panel are closely arranged side by side so that the heat exchange surface of the heat exchange panel follows the side surface of one or both battery cells at every other location between the battery cells, the required heat exchange property can be obtained. In addition, even when the battery cell and the heat exchange panel are closely arranged side by side so that the heat exchange surface of the heat exchange panel follows the side surface of one or both battery cells a small number of locations such as two or three locations smaller than the locations between the plurality of battery cells such as one, two, or three locations among all locations between the plurality of battery cells, it is possible to reduce the cost and the weight of the heat exchange fluid.

### INDUSTRIAL APPLICABILITY

The present invention can be used, for example, when performing heat exchange with respect to a battery of an electric vehicle or the like.

### REFERENCE SIGNS LIST

1: Insulating container
2: Insulating container main body
21: Inner wall
211: Bottom portion
212: Peripheral side portion
213: Flange
22: Outer wall
221: Bottom portion
222: Peripheral side portion
223: Flange
23: Container-side flat flange
24: Penetrating portion
3: Insulating lid
31: Inner lid
311: Substrate
312: Erected portion
313: Flange
32: Outer lid
33: Lid-side flat flange
4: Battery body
41: Battery cell
411: Side surface
42: Heat exchange panel
421: Heat exchange surface
422: Inlet port
423: Outlet port
424, 425: Partition
51, 52: Holding plate
61, 71: Support stay
62, 72: Insulating material
63, 73: Bolt
81: Shaft bolt
82, 83, 84: Nut
85: Washer
86: Coil spring
91: Fluid supply pipe
911: Fluid lead-out pipe
912: Connecting pipe
913: Protruding pipe
92: Fluid discharge pipe
921: Fluid lead-out pipe
922: Connecting pipe
923: Protruding pipe
10: Cap
101: Insertion hole
100: Battery heat exchange structure
11: Temperature sensor
12: Heat exchange fluid control unit
13: Heat exchange fluid storage unit
S1, S2, S3, S4: Insulating space
F: Heat exchange fluid

1-7. (canceled)

8. A battery heat exchange structure in which
a battery cell and a heat exchange panel are closely arranged side by side so that a heat exchange surface of the heat exchange panel follows a side surface of the battery cell,
the heat exchange panel is formed so that a heat exchange fluid can be recirculated along the heat exchange surface, and
the heat exchange panel and the battery cell are elastically urged so as to be compressed in the arrangement direction.

9. The battery heat exchange structure according to claim 8, wherein
the battery cell and the heat exchange panel are closely arranged side by side between one holding plate provided at one end in the arrangement direction and the other holding plate provided at the other end, and
the battery cell and the heat exchange panel are urged by an elastic material from an outer side of one holding plate or from both outer sides of both holding plates so that a compressive force is applied substantially uniformly to the heat exchange surface of the heat exchange panel.

10. The battery heat exchange structure according to claim 8, wherein
a portion of a fluid supply pipe for supplying the heat exchange fluid to the heat exchange panel and a portion of a fluid discharge pipe for discharging the heat exchange fluid from the heat exchange panel are provided so as to follow the arrangement direction, and
the heat exchange fluid supplied by the fluid supply pipe is distributed and recirculated to a plurality of heat exchange panels arranged side by side, and is discharged from the heat exchange panels so as to be collected in the fluid discharge pipe.

11. The battery heat exchange structure according to claim 9, wherein
a portion of a fluid supply pipe for supplying the heat exchange fluid to the heat exchange panel and a portion of a fluid discharge pipe for discharging the heat exchange fluid from the heat exchange panel are provided so as to follow the arrangement direction, and
the heat exchange fluid supplied by the fluid supply pipe is distributed and recirculated to a plurality of heat exchange panels arranged side by side, and is discharged from the heat exchange panels so as to be collected in the fluid discharge pipe.

12. The battery heat exchange structure according to claim 10, wherein
a portion of the fluid supply pipe between the heat exchange panels and a portion of the fluid discharge pipe between the heat exchange panels are formed of an elastic pipe.

13. The battery heat exchange structure according to claim 11, wherein
a portion of the fluid supply pipe between the heat exchange panels and a portion of the fluid discharge pipe between the heat exchange panels are formed of an elastic pipe.

14. The battery heat exchange structure according to claim 8, wherein
a battery body including the battery cell and the heat exchange panel, and a support portion for supporting the battery body are housed in an insulating container.

15. The battery heat exchange structure according to claim 9, wherein
a battery body including the battery cell and the heat exchange panel, and a support portion for supporting the battery body are housed in an insulating container.

16. The battery heat exchange structure according to claim 10, wherein
a battery body including the battery cell and the heat exchange panel, and a support portion for supporting the battery body are housed in an insulating container.

17. The battery heat exchange structure according to claim 11, wherein
a battery body including the battery cell and the heat exchange panel, and a support portion for supporting the battery body are housed in an insulating container.

18. The battery heat exchange structure according to claim 14, wherein
the insulating container is a double-walled insulating container including an insulating container main body in which an insulating space is provided between an inner wall and an outer wall, and an insulating lid in which an insulating space is provided between an inner lid and an outer lid, and
the battery body is arranged to be spaced apart from the inner wall of the insulating container main body and the inner lid of the insulating lid.

19. The battery heat exchange structure according to claim 15, wherein
the insulating container is a double-walled insulating container including an insulating container main body in which an insulating space is provided between an inner wall and an outer wall, and an insulating lid in which an insulating space is provided between an inner lid and an outer lid, and
the battery body is arranged to be spaced apart from the inner wall of the insulating container main body and the inner lid of the insulating lid.

20. The battery heat exchange structure according to claim 16, wherein
the insulating container is a double-walled insulating container including an insulating container main body in which an insulating space is provided between an inner wall and an outer wall, and an insulating lid in which an insulating space is provided between an inner lid and an outer lid, and
the battery body is arranged to be spaced apart from the inner wall of the insulating container main body and the inner lid of the insulating lid.

21. The battery heat exchange structure according to claim 17, wherein
the insulating container is a double-walled insulating container including an insulating container main body in which an insulating space is provided between an inner wall and an outer wall, and an insulating lid in which an insulating space is provided between an inner lid and an outer lid, and
the battery body is arranged to be spaced apart from the inner wall of the insulating container main body and the inner lid of the insulating lid.

22. The battery heat exchange structure according to claim 8, wherein
a temperature sensor for detecting a temperature of the battery cell is provided close to the battery cell, and
a heat exchange fluid control unit supplies the heat exchange fluid having a required temperature according to a detection temperature from the temperature sensor.

23. The battery heat exchange structure according to claim 9, wherein
a temperature sensor for detecting a temperature of the battery cell is provided close to the battery cell, and
a heat exchange fluid control unit supplies the heat exchange fluid having a required temperature according to a detection temperature from the temperature sensor.

24. The battery heat exchange structure according to claim 10, wherein
a temperature sensor for detecting a temperature of the battery cell is provided close to the battery cell, and
a heat exchange fluid control unit supplies the heat exchange fluid having a required temperature according to a detection temperature from the temperature sensor.

25. The battery heat exchange structure according to claim 11, wherein
a temperature sensor for detecting a temperature of the battery cell is provided close to the battery cell, and
a heat exchange fluid control unit supplies the heat exchange fluid having a required temperature according to a detection temperature from the temperature sensor.

26. The battery heat exchange structure according to claim 12, wherein
a temperature sensor for detecting a temperature of the battery cell is provided close to the battery cell, and
a heat exchange fluid control unit supplies the heat exchange fluid having a required temperature according to a detection temperature from the temperature sensor.

27. The battery heat exchange structure according to claim 13, wherein
a temperature sensor for detecting a temperature of the battery cell is provided close to the battery cell, and
a heat exchange fluid control unit supplies the heat exchange fluid having a required temperature according to a detection temperature from the temperature sensor.
